(19) United States
(12) Patent Application Publication
(10) Pub. No.: US 2007/0070024 A1
(43) Pub. Date: Mar. 29, 2007

(54) Liquid crystal display device

(76) Inventors: Shigesumi Araki, Ishikawa-gun (JP); Kazuhiro Nishiyama, Kanazawa-shi (JP); Mitsutaka Okita, Hakusan-shi (JP); Daiichi Suzuki, Sendai-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/524,936

(22) Filed: Sep. 22, 2006

(30) Foreign Application Priority Data
Sep. 29, 2005 (JP) 2005-283544
Aug. 10, 2006 (JP) 2006-218586

(51) Int. Cl. G09G 3/36

(52) U.S. Cl. 345/102

(57) ABSTRACT

A liquid crystal display device, which performs color display by sequentially displaying different color images in a time division manner and mixing the color images, includes a liquid crystal display panel in which a liquid crystal layer is held between a pair of substrates, color light sources of a plurality of colors, and a controller circuit which controls each of the color light sources and the liquid crystal display panel. The controller circuit controls a time opening ratio and an emission light luminance of one of the color light sources, which emits light of a color with which coloring occurs in transmissive light emerging from the liquid crystal display panel at a time of black display, thereby reducing the coloring of the transmissive light and maintaining a white balance.

### CROSS-REFERENCE TO RELATED APPLICATIONS

This application is based upon and claims the benefit of priority from prior Japanese Patent Applications No. 2005-283544, filed Sep. 29, 2005; and No. 2006-218586, filed Aug. 10, 2006, the entire contents of both of which are incorporated herein by reference.

### BACKGROUND OF THE INVENTION

1. Field of the Invention

The present invention relates generally to a liquid crystal display device, and more particularly to a liquid crystal display device to which an OCB (Optically Compensated Birefringence) mode is applied.

2. Description of the Related Art

In recent years, there has been proposed a liquid crystal display device of a so-called field sequential driving system, wherein respective colors are mixed to perform color display by sequentially displaying different color images at high speed in a time division manner. In this liquid crystal display device, since color display is performed in the time division manner, a color filter, which is indispensable for color display in conventional liquid crystal display devices, is needless. In addition, since color images of three colors are successively displayed by one pixel, the field sequential driving system can advantageously realize, compared to the conventional driving system, an increase in fineness, a decrease in cost and high efficiency of use of backlight.

In the case where this driving system is adopted, since it is necessary to display color images of at least three colors in 1 field period, high-speed responsivity characteristics are required. To meet this requirement, a liquid crystal display device to which an OCB mode is applied is effective. It is expected that the OCB mode liquid crystal display device can realize the high-speed responsivity characteristics by bend-aligning liquid crystal molecules of a nematic liquid crystal (see, e.g. Jpn. Pat. Appln. KOKAI Publication No. 2003-131191).

However, the OCB mode liquid crystal display device, as a single unit, cannot perform good black display, and optical compensation using, e.g. a phase plate, is needed. In this case, the wavelength dispersion characteristics of a member, such as a phase plate, are, in many cases, different from those of the liquid crystal material. Consequently, it is very difficult to perform perfect optical compensation in the entire wavelength range. Thus, when a black image is displayed, such a problem arises that coloring of the black image occurs.

### BRIEF SUMMARY OF THE INVENTION

The present invention has been made in consideration of the above-described problem, and the object of the invention is to provide a liquid crystal display device with good display quality.

According to an aspect of the present invention, there is provided a liquid crystal display device which performs color display by mixing different color images which are displayed in a time division manner, comprising:
a liquid crystal display panel in which a liquid crystal layer is held between a pair of substrates;
color light sources of a plurality of colors; and
control means for controlling each of the color light sources and the liquid crystal display panel,
wherein the control means controls a time opening ratio and an emission light luminance of one of the color light sources, which emits light of a color with which coloring occurs in transmissive light emerging from the liquid crystal display panel at a time of black display, thereby reducing the coloring of the transmissive light and maintaining a white balance.

This invention can provide a liquid crystal display device with good display quality.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view that schematically shows the structure of a liquid crystal display device according to an embodiment of the present invention;

FIG. 2 is a cross-sectional view that schematically shows the structure of a liquid crystal display panel which is applied to the liquid crystal display device shown in FIG. 1;

FIG. 3 is a view for explaining an operational concept for obtaining a predetermined white balance;

FIG. 4 is a view for explaining an operational concept for realizing both a predetermined white balance and elimination of coloring at the time of black display;

FIG. 5 is a view for describing 10×-speed driving for realizing both a predetermined white balance and elimination of coloring at the time of black display;

FIG. 6 is a view for describing 12×-speed driving (4-field structure) for realizing both a predetermined white balance and elimination of coloring at the time of black display; and

FIG. 7 is a view for describing 15×-speed driving (5-field structure) for realizing both a predetermined white balance and elimination of coloring at the time of black display.

### DETAILED DESCRIPTION OF THE INVENTION

A liquid crystal display device according to an embodiment of the present invention will now be described with reference to the accompanying drawings. In this embodiment, in particular, a liquid crystal display device, to which an OCB (Optically Compensated Birefringence) mode is applied, is exemplified as the liquid crystal display device.

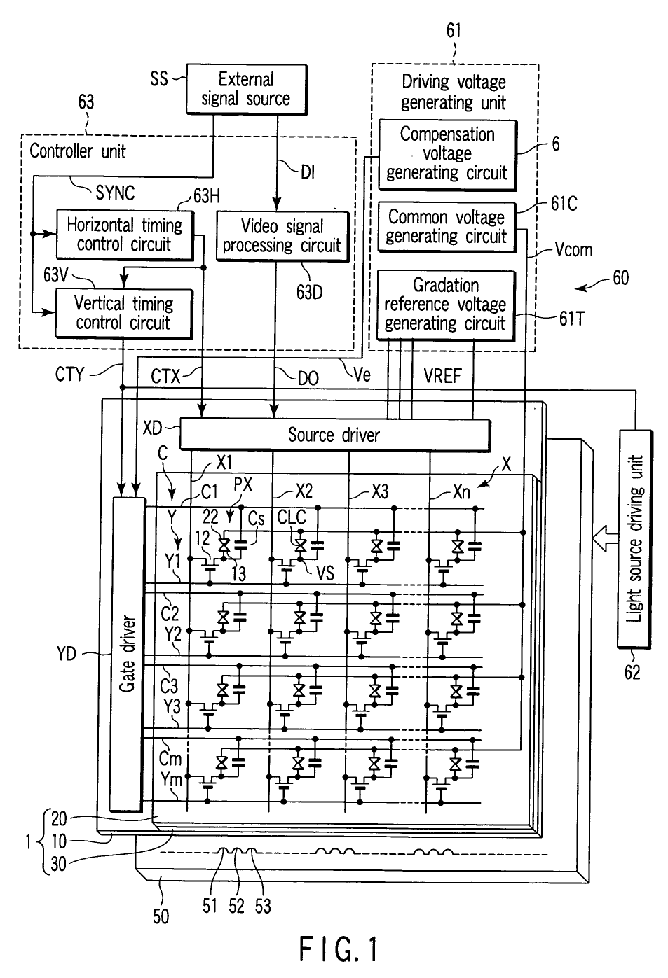

As is shown in FIG. 1, the liquid crystal display device includes an OCB mode liquid crystal display panel 1 and an area light source unit, that is, a backlight unit 50, for illuminating the liquid crystal display panel 1. Further, the liquid crystal display panel includes a display control circuit 60 which functions as control means for controlling the liquid crystal display panel 1 and backlight unit 50.

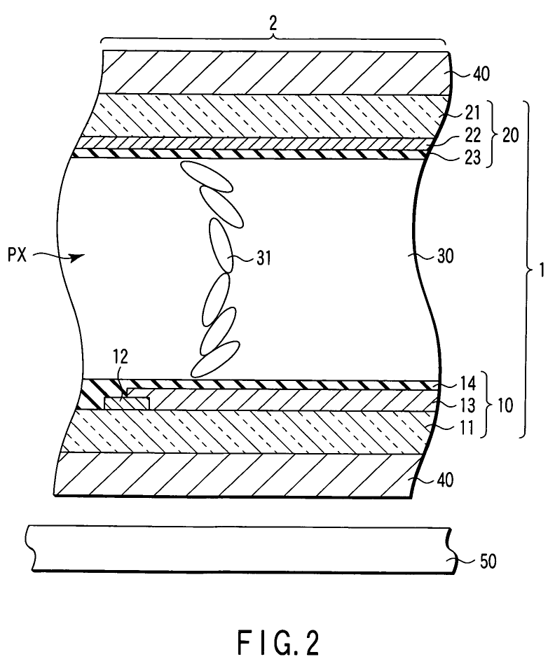

The liquid crystal display panel 1 is, for example, of a transmissive type, and is configured such that a liquid crystal layer 30 is held between a pair of substrates, that is, an array substrate 10 and a counter-substrate 20. The liquid crystal display panel 1 has a plurality of display pixels PX which are arranged in a matrix. As shown in FIG. 2, the array substrate 10 is formed by using a light-transmissive insulating substrate 11 such as a glass substrate. The array substrate 10 includes, on one major surface of the insulating substrate 11, a plurality of scan lines Y (Y1 to Ym) which are disposed in a row direction of the display pixels PX; a plurality of signal lines X (X1 to Xn) which are disposed in a column direction of the display pixels PX; switch elements 12 which are disposed near intersections between the scan lines Y and signal lines X in association with the respective display pixels PX; pixel electrodes 13 which are connected to the switch elements 12 and are disposed in association with the respective display pixels PX; and an alignment film 14 which is disposed so as to cover the entire major surface of the insulating substrate 11.

The switch elements 12 are composed of, e.g. TFTs (Thin Film Transistors). The switch element 12 of each display pixel has, for example, a gate connected to the associated scan line Y, a source connected to the associated signal line X, and a drain connected to the associated pixel electrode 13. When the switch element 12 is driven via the associated scan line Y, the switch element 12 is rendered conductive between the associated signal line X and associated pixel electrode 13.

The pixel electrodes 13 are formed of a light-transmissive electrically conductive material such as ITO (Indium Tin Oxide). If the display device is constructed as a reflective display device using, e.g. front light, the pixel electrodes 13 may be formed of a reflective material such as aluminum (Al). The surfaces of the pixel electrodes 13 are covered with an alignment film 14.

The counter-substrate 20 is formed by using a light-transmissive insulating substrate 21 such as a glass substrate. The counter-substrate 20 includes, on one major surface of the insulating substrate 21, a counter-electrode 22 and an alignment film 23. The counter-electrode 22 is disposed common to the plural display pixels PX, and is formed of a light-transmissive electrically conductive material such as ITO. The alignment film 23 is so disposed as to cover the entire major surface of the insulating substrate 21, and is formed of a light-transmissive material.

The array substrate 10 and counter-substrate 20 having the above-described structures are coupled to each other by a sealing member in the state in which a predetermined gap is kept between the array substrate 10 and counter-substrate 20 via spacers (not shown). The liquid crystal layer 30 is sealed in the gap (e.g. about 5 μm) between the array substrate 10 and counter-substrate 20. A material having a positive dielectric constant anisotropy and optically positive uniaxial (e.g. MT5623 manufactured by CHISSO Corporation) is selectable for liquid crystal molecules 31 which are included in the liquid crystal layer 30.

Each of the display pixels PX has a liquid crystal capacitance CLC between the associated pixel electrode 13 and the counter-electrode 22. A plurality of storage capacitance lines C (C1 to Cm) are capacitive-coupled to the pixel electrodes 13 of the display pixels PX of the associated rows, thus constituting storage capacitances Cs.

The above-described OCB liquid crystal display device includes an optical compensation element 40 which optically compensates retardation of the liquid crystal layer 30 including bend-aligned liquid crystal molecules 31, as shown in FIG. 2, in a predetermined display state in which a voltage is applied to the liquid crystal layer 30. For example, a pair of optical compensation elements 40 are formed for the transmissive liquid crystal display panel 1. Specifically, one optical compensation element 40 is disposed on the outer surface of the array substrate 10, and the other optical compensation element 40 is disposed on the outer surface of the counter-substrate 20. Each of the optical compensation elements 40 is configured to include a polarizer plate and a phase plate.

The backlight unit 50 is disposed on the outside of the optical compensation element 40 which is located on the array substrate 10 side. The backlight unit 50 includes a plurality of kinds of color light sources, for example, color light sources of the three primary colors (i.e. a red light source 51 which emits red light, a green light source 52 which emits green light and a blue light source 53 which emits blue light). In this embodiment, the red light source 51, green light source 52 and blue light source 53 are composed of light-emitting diodes (LEDs) respectively.

The display control circuit 60 has a function of controlling the transmittance of the liquid crystal panel 1 in units of each of fields which display images of respective colors, and controlling a turn-on timing of the color light sources of the backlight unit 50 in sync with the control of the transmittance.

Specifically, the display control circuit 60 is configured to include a gate driver YD which sequentially drives the plural scan lines Y1 to Ym so as to turn on plural switch elements 12 on a row-by-row basis; a source driver XD which outputs pixel voltages Vs to the plural signal lines X1 to Xn during a period in which the switch elements 12 of each row are turned on by the driving of the associated scan line Y; a driving voltage generating unit 61 which generates a driving voltage for the liquid crystal display panel 1; a light source driving unit 62 which controls driving of the backlight BL; and a controller unit 63 which controls the gate driver YD, the source driver XD and the light source driving unit 62.

The driving voltage generating unit 61 includes a compensation voltage generating circuit 6 which generates a compensation voltage Ve that is to be applied to the storage capacitance lines C via the gate driver YD; a gradation reference voltage generating circuit 61T which generates a predetermined number of gradation reference voltages VREF for use in the source driver XD; and a common voltage generating circuit 61C which generates a common voltage Vcom that is to be applied to the counter-electrode 22.

The controller unit 63 includes a vertical timing control circuit 63V which generates a control signal CTY to the gate driver YD on the basis of a sync signal SYNC that is input from an external signal source SS; a horizontal timing control circuit 63H which generates a control signal CTX to the source driver XD on the basis of the sync signal SYNC that is input from the external signal source SS; and a video signal processing circuit 63D which processes a video signal DI that is input in a digital format from the external signal source SS in association with the plural pixels PX.

The control signal CTY is supplied to the gate driver YD, and enables the gate driver YD to execute an operation of sequentially driving the plural scan lines Y. The control signal CTX, together with a processing result of the video signal processing circuit 63D, is supplied to the source driver XD, and enables the source driver XD to execute an operation of assigning a video signal DO, which is obtained in units of display pixels PX for one row as the processing result of the video signal processing circuit 63 and is serially output, to the plural signal lines X, and designating output polarities.

The gate driver YD sequentially selects the plural scan lines Y1 to Ym under the control of the control signal CTY, and supplies the selected scan line Y with an ON-voltage as a driving signal for turning on the pixel switch elements 12 of the associated row. The source driver XD converts the video signal DO to pixel voltages Vs by referring to the predetermined number of gradation reference voltages VREF, which are supplied from the gradation reference voltage generating circuit 61T, and outputs the pixel voltages Vs to the plural signal lines X1 to Xn in a parallel fashion.

The pixel voltage Vs is a voltage that is applied to the pixel electrode 13 with reference to the common voltage Vcom of the counter-electrode 22. For example, the polarity of the pixel voltage Vs is reversed with respect to the common voltage so as to execute frame-inversion driving and line-inversion driving.

The light source driving unit 62 causes the color light sources, which emit light of colors in association with fields of color images, to successively emit light on the basis of the control signal CTY that is output from the vertical timing control circuit 63V. In addition, the light source driving unit 62 controls the emission light luminance by controlling the amount of electric current that is supplied to each color light source.

The above-described liquid crystal display device adopts a so-called field sequential driving method in which different color images are displayed at high speed in a time division manner, thereby mixing the color images and performing color display. The field sequential driving method will now be explained in brief. The backlight unit 50 divides 1 frame period into 3 field periods under the control of the light source driving unit 62, and sets each of the 3 field periods (i.e. ⅓ frame period) to be a light emission period for the associated light source. In other words, the backlight unit 50 sequentially turns on the red light source (R) 51, green light source (G) 52 and blue light source (B) 53 in each light emission period, and illuminates the liquid crystal display panel with the light from the respective color light sources. The transmittance of the liquid crystal display panel 1 is controlled by the display control circuit 60 in sync with the light emission of the respective color light sources of the backlight unit 50, and the associated color images are sequentially displayed. As described above, the liquid crystal display device can perform color display by varying the transmittance with respect to the light from each color light source.

An operational concept of the liquid crystal display device, in which the field sequential driving method and the OCB mode are combined, is explained. It is assumed that the liquid crystal display panel 1 executes, under the control of the display control circuit 60, black insertion driving, in which a black image is displayed for a predetermined time period, in order to improve motion video responsivity and maintain bend alignment. In the backlight unit 50, the light emission period of each color light source is set at a ⅓ frame period. A description is given of the case where black insertion driving with an equal period is executed for each color image, that is, for the ⅓ frame period of light emission from each color light source.

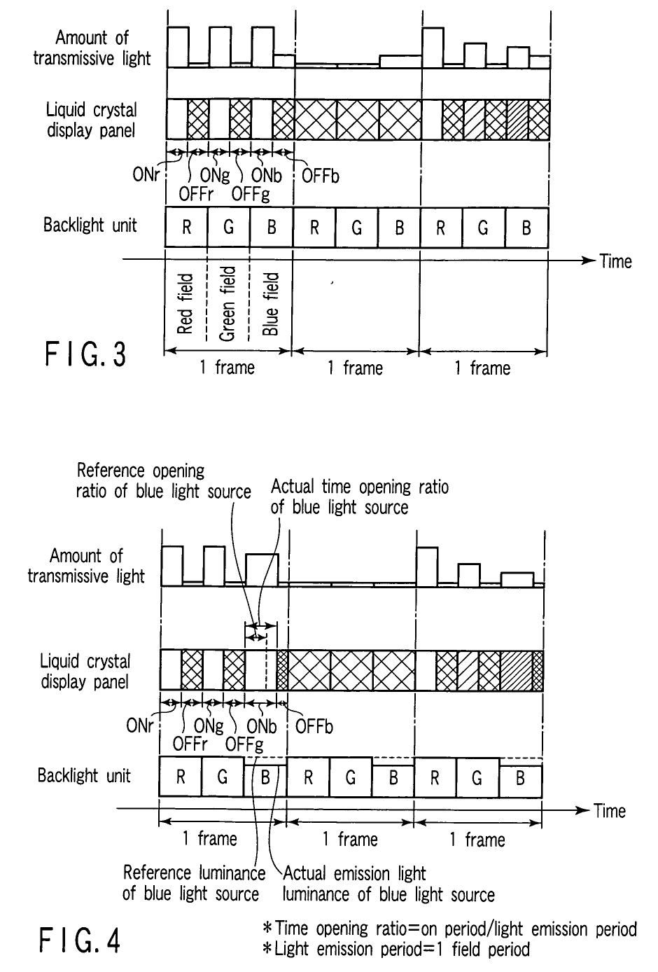

For example, as shown in FIG. 3, the display control circuit 60 controls the driving of the liquid crystal display panel 1 such that the ⅓ frame period for light emission from the red light source 51 includes, with a predetermined ratio, an ON period ONr in which red light is transmittable and an OFF period (black insertion period) OFFr in which red light is not transmittable. Similarly, the ⅓ frame period for light emission from the green light source 52 includes, with a predetermined ratio, an ON period ONg in which green light is transmittable and an OFF period (black insertion period) OFFg in which green light is not transmittable. The ⅓ frame period for light emission from the blue light source 53 includes, with a predetermined ratio, an ON period ONb in which blue light is transmittable and an OFF period (black insertion period) OFFb in which blue light is not transmittable.

In each ⅓ frame period, the ratio between the ON period and OFF period is basically the same. By controlling the transmittance of the liquid crystal display panel 1, the amount of transmissive light is controlled and a predetermined color is reproduced. When a black image is reproduced, the transmittance is reduced to substantially zero in the ON period of each ⅓ frame period and accordingly the entire 1 frame period becomes the OFF period.

In the example shown in FIG. 3, the amount of transmissive light from the liquid crystal display panel 1 is adjusted so that a desired white balance may be obtained when a white image is displayed. Specifically, the amount of transmissive light can be defined as a value that is obtained by multiplying the emission light luminance of the color light source, the ON period of the liquid crystal display panel 1 and the transmittance of the liquid crystal display panel 1. If the transmittance of the liquid crystal display panel 1 at the time of displaying a white image is set at substantially 100%, a control is executed to obtain a predetermined white balance by the ON period of the liquid crystal display panel 1, which is controlled by the display control circuit 60, and the emission light luminance of each color light source, which is controlled by the light source driving unit 62.

As described above, the liquid crystal display panel 1 is driven so that each ⅓ frame period, during which each color light source emits light, includes the ON period and OFF period, and impulse-type transmissive light characteristics are obtained. Thereby, the motion video characteristics can be improved and at the same time the bend alignment can be maintained. Therefore, color display with the advantageous high-speed responsivity of the OCB mode is realized.

Although the OCB mode liquid crystal display device reproduces a black image by the optical compensation using the optical compensation elements, it is difficult to execute perfect optical compensation in the entire wavelength range that is used for color display, due to, e.g. wavelength dispersion characteristics of phase plates, etc. Consequently, when a black image is reproduced, light of a wavelength, which is not fully optically compensated, leaks from the liquid crystal display panel 1 to a greater degree than light of other wavelengths, and coloring of a black image may occur. In the example of FIG. 3, a greater amount of light of a blue wavelength leaks from the liquid crystal display panel 1 than light of other wavelengths. As a result, a black image becomes bluish.

In the present embodiment, an emission light luminance of each color light source, which is needed to obtain a predetermined white balance with transmissive light which emanates from the backlight unit 50 and passes through the liquid crystal display panel 1, is set to be a reference luminance. A time opening ratio of the liquid crystal display panel 1, with which light from each color light source which is needed to obtain a predetermined white balance is transmitted, is set to be a reference opening ratio. In this case, the display control circuit 60 makes the emission light luminance of a predetermined color light source different from the reference luminance so as to obtain black without undesirable coloring, and makes the time opening ratio of the liquid crystal display panel 1 at a time, when light from the predetermined color light source is transmitted, different from the reference opening ratio. In other words, the display control circuit 60 controls the time opening ratio and emission light luminance of the color light source, which emits light of a color with which coloring occurs in transmissive light emerging from the liquid crystal display panel 1 at a time of black display, so as to reduce the coloring of the transmissive light and to maintain a good white balance. The time opening ratio, in this context, refers to a ratio of the ON period to the light emission period (e.g. ⅓ frame period) of each light source.

In the example of FIG. 3, the black image becomes bluish. In this case, as shown in FIG. 4, in the display control circuit 60, the light source driving unit 62 sets the emission light luminance of the blue light source 53 to be lower than the reference luminance, and the driving voltage generating unit 61 and controller unit 63 set the time opening ratio of the liquid crystal display panel 1 at a time, when light from the blue light source 53 is transmitted, to be greater than the reference opening ratio.

By setting the emission light luminance of the blue light source 53 to be lower than the reference luminance, the amount of leak light of the blue wavelength from the liquid crystal display panel can be made equal to the amount of light of other color wavelengths even if the light of the blue wavelength is not sufficiently optically compensated by the optical compensation elements 40. Thus, the bluish coloring of the black image, as shown in FIG. 3, which occurs when the blue light source 53 is caused to emit light with the reference luminance, can be suppressed, and black with good quality can be obtained.

In the case where the emission light luminance of the blue light source 53 is set to be lower than the reference luminance, if the time opening ratio of the liquid crystal display panel 1 is set at the reference opening ratio (e.g. if the time opening ratio for displaying a blue image is set to be equal to the time opening ratio for displaying other color images), the amount of light of the blue wavelength would become deficient and the white balance would deteriorate. Thus, during the period in which the blue light source 53 emits light, the display control circuit 60 sets the ON period ONb of the liquid crystal display panel 1 to be longer than in the example of FIG. 3. Thereby, the time opening ratio of the liquid crystal display panel 1 at a time, when the light from the blue light source 53 is transmitted, becomes longer than the reference opening ratio.

As described above, by controlling the emission light luminance of the blue light source 53 and the time opening ratio of the liquid crystal display panel 1, it becomes possible to obtain substantially the same amount of transmissive light as in the case where the blue light source 53 is caused to emit light with the reference luminance and the liquid crystal display panel 1 is driven with the reference opening ratio during the period in which the blue light source 53 emits light. Therefore, like the driving as shown in the example of FIG. 3, a desired white balance can be obtained.

To obtain a desired white balance means to obtain proper chromaticity. For example, the amount of transmissive light from the respective color light sources may be adjusted so that relative color temperatures become equal (the relative color temperature of black and the relative color temperature of white become substantially equal at, e.g. 10000K).

In order to adjust the amount of transmissive light, the emission light luminance of each color light source is controlled by the display control circuit 60. In particular, in the case where the color light sources are composed of light-emitting diodes, the emission light luminance may be controlled by the amount of electric current that is supplied to each color light source. For example, in the case where the red field, green field and blue field are set at equal periods and the time opening ratios are set to be equal, as shown in FIG. 3, the emission light luminances (reference luminance) of the color light sources, which are necessary in order to obtain a predetermined white balance, are as follows. As regards the red light source 51, the peak current amount is set at 400 mA in order to obtain the emission light luminance of 80 cd/m². As regards the green light source 52, the peak current amount is set at 500 mA in order to obtain the emission light luminance of 200 cd/m². As regards the blue light source 53, the peak current amount is set at 400 mA in order to obtain the emission light luminance of 20 cd/m².

On the other hand, as in the example of FIG. 4, in the case where the time opening ratio in the blue field is set to be greater than the time opening ratio in the other color fields in order to improve the bluish coloring of the black image (i.e. in the case where the time opening ratio in the blue field is set to be greater than the reference opening ratio), the above-described emission light luminances are set for the red light source 51 and green light source 52. However, the emission light luminance of the blue light source 53, which is needed to obtain a predetermined white balance, is 17.5 cd/m². In order to obtain this emission light luminance, the peak current amount is set at 350 mA.

In order to adjust the amount of transmissive light, the display control circuit 60 controls the time opening ratio in the period in which each light source of the liquid crystal display panel 1 emits light. In particular, in the driving method in which the black insertion period is provided during the period in which each color light source emits light, the time opening ratio may be adjusted by the black insertion period. For example, in the case where the black image becomes bluish due to coloring, as in the above-described embodiment, the time opening ratio in the blue field is set to be greater than the time opening ratio in the other color fields. In the case where the time opening ratio of each color light source is the same (e.g. 50%) as in the example of FIG. 3, in order to improve the bluish coloring, the time opening ratio of the blue light source 53 is set to be greater than the time opening ratios of the other color light sources, for example, at 57%, as shown in FIG. 4, while the time opening ratios of the red light source 51 and green light source 52 are kept at the same value (50%). In the case where the field periods of the respective color images, which are displayed in sync with the light emission of the respective color light sources, are set to be equal, that is, in the case where the light emission periods of the respective color light sources are set to be equal, the above-described control of the time opening ratio can be adjusted by the OFF period, i.e. the black insertion period. In this example, the black insertion period in the blue field period is set to be shorter than the black insertion period in each of the red field period and green field period. Thereby, the time opening ratio of the blue light source 53 can be set to be greater than the time opening ratio of each of the red light source 51 and green light source 52.

The control of the time opening ratio is not limited to the above example in which the time opening ratio is controlled by the black insertion period. For example, in the case where the black image becomes bluish due to coloring, the field period of the blue image, which is displayed in sync with the light emission of the blue light source 53, may be set to be greater than each of the field periods of color images which are displayed in sync with the light emission of the other color light sources. In this case, even if the black insertion period is set to be equal in the respective field periods, the time opening ratio of the blue light source 53 can be set to be greater than the time opening ratios of the other color light sources.

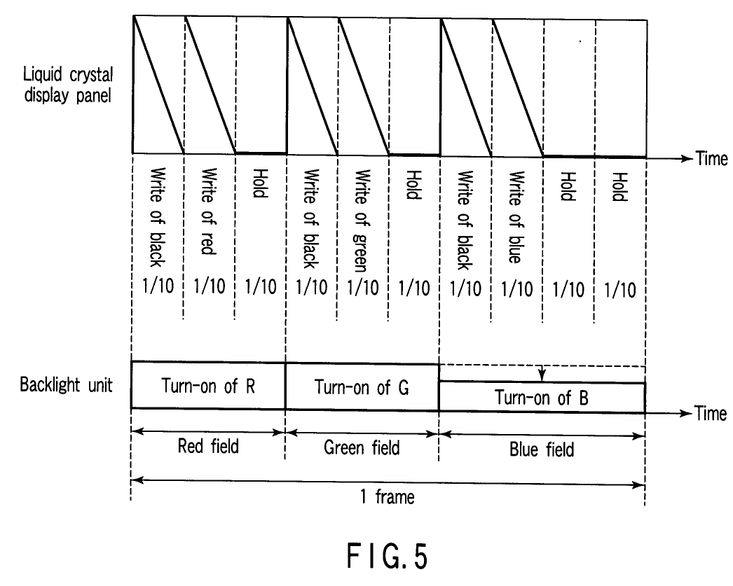

Referring to an example shown in FIG. 5, a correction method for reducing the bluish coloring of the black image is described. For simple description, 10×-speed driving is exemplified in FIG. 5. In 1 frame, a 3/10 frame period is assigned to the red field period, a 3/10 frame period is assigned to the green field period, and a 4/10 frame period is assigned to the blue field period. The display control circuit 60 turns on the red light source 51 in the red field period ( 3/10 frame period), turns on the green light source 52 in the green field period ( 3/10 frame period), and turns on the blue light source 53 in the blue field period ( 4/10 frame period). In short, the light emission period of the blue light source 53 is set to be longer than each of the light emission periods of the other color light sources.

On the other hand, in the liquid crystal display panel 1, a 1/10 frame period of 1 frame is assigned as a black insertion period in each of the field periods of the respective colors. The display control circuit 60 executes driving so as to write a black image in the liquid crystal display panel 1 in each black insertion period. Specifically, in each of the red field period and green field period, the display control circuit 60 writes a black image in the liquid crystal display panel 1 in the first 1/10 frame period. In the subsequent 1/10 frame period, the display control circuit 60 writes a red signal image or a green signal image in the liquid crystal display panel 1. Further, in the subsequent 1/10 frame period, the display control circuit 60 executes driving so as to hold the red or green signal image that has been written. On the other hand, in the blue field period, the display control circuit 60 writes a black image in the liquid crystal display panel 1 in the first 1/10 frame period. In the subsequent 1/10 frame period, the display control circuit 60 writes a blue signal image in the liquid crystal display panel 1. Further, in the subsequent 2/10 frame period, the display control circuit 60 executes driving so as to hold the blue signal image that has been written.

At the same time, the display control circuit 60 decreases the emission light luminance of the blue light source 53.

In the above-described 10×-speed driving, in order to correct the bluish coloring of the black image, the blue field period is set to be longer than each of the other color field periods (i.e. the light emission period of the blue light source is set to be longer than each of the light emission periods of the other color light sources), and the black insertion period is set to be equal in the respective color field periods. Thereby, the time opening ratio (75%) for the blue light source is set to be greater than the time opening ratio (66%) for the other color light sources.

In a 9×-speed driving, a 3/9 frame period of 1 frame was assigned to each of the respective color field periods, and a 1/9 frame period was assigned as a black insertion period in each color field period (i.e. the time opening ratio for each of the respective color light sources was set at 66%). In this 9×-speed driving, the emission light luminance of the blue light source 53, which is necessary in order to obtain a predetermined white balance, was 20 cd/m². On the other hand, in the case of the above-described 10×-speed driving, the emission light luminance of the blue light source is 17.5 cd/m². In order to obtain this emission light luminance, the peak current amount is set at 350 mA.

With this structure, the white balance can be maintained while the coloring of transmissive light emerging from the liquid crystal display panel at the time of black display can be reduced. A liquid crystal display device with good display quality can be provided.

In the above-described embodiment, for the purpose of simple description, the 10×-speed driving is exemplified. However, 9.2×- to 9.8×-speed driving is desirable in consideration of the optimization of the transmissive light amount, the light emission efficiency of the respective color light sources of the backlight unit and the simplification of driving.

In the above-described embodiment, 1 frame comprises three fields, that is, one red field period, one green field period and one blue field period. Alternatively, 1 frame may comprise four or more fields. For example, in a case where color breakup of a specific color is subjectively visually recognized when high-multiple-speed driving is executed, there is known a technique wherein the number of fields of colors, other than the specific color, is increased and the ratio of display of the specific color image in 1 frame is substantially reduced, thereby reducing the color breakup (see, e.g. Jpn. Pat. Appln. KOKAI Publication No. 2003-287733). According to this technique, if white is set by a red component:a green component:a blue component=1:1:1, the emission light intensities of the light sources are set such that the red component of 1 is assigned to one field, the green component of 0.5 is assigned to each of two fields, and the blue component of 0.5 is assigned to each of two fields. In an example that is disclosed, in a case where the luminance ratio of R:G:B is 3:6:1 and a white luminance of about 200 cd/m² is to be output, the red field is set at 60 cd/m², the green field is set at 60 cd/m², and the blue field is set at 10 cd/m². However, in the liquid crystal display device to which the OCB mode is applied, there remains such a problem that coloring occurs with respect to a specific color when a black image is displayed, due to problems of optical compensation.

In an example for reducing coloring of a black image and improving color breakup, it can be thought to form 1 frame of 4 or more fields, as will be described below. In this example, in order to reduce bluish coloring of the black image, the emission light luminance and the time opening ratio of the blue light source are controlled. In addition, in order to improve color breakup of red, the display ratio of the red image in 1 frame is decreased.

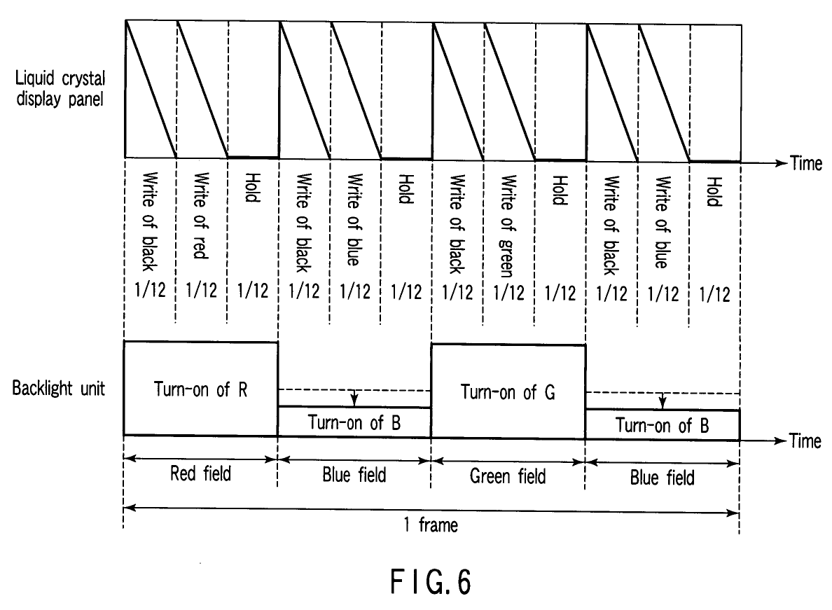

FIG. 6 shows the case of a 4-field structure in 12×-speed driving. In 1 frame, a red field period corresponding to a 3/12 frame period, a blue field period corresponding to a 3/12 frame period, a green field period corresponding to a 3/12 frame period and a blue field period corresponding to a 3/12 frame period are successively assigned. The display control circuit 60 turns on the red light source 51 in the red field period ( 3/12 frame period), then turns on the blue light source 53 in the first blue field period ( 3/12 frame period), then turns on the green light source 52 in the green field period ( 3/12 frame period), and then turns on the blue light source 53 in the second blue field period ( 3/12 frame period). In short, the light emission period ( 6/12 frame period) of the blue light source 53 in the 1 frame is set to be longer than each of the light emission periods ( 3/12 frame period) of the other color light sources.

On the other hand, in the liquid crystal display panel 1, a 1/12 frame period of 1 frame is assigned as a black insertion period in each of the field periods of the respective colors. The display control circuit 60 executes driving so as to write a black image in the liquid crystal display panel 1 in each black insertion period. Thus, in 1 frame, the time opening ratio for the blue light source 53 is greater than the time opening ratio for each of the red light source 51 and green light source 52.

At the same time, the display control circuit 60 decreases the emission light luminance of the blue light source 53. For example, in a case where the luminance ratio of R:G:B is 3:6:1 and a white luminance of about 200 cd/m² is to be output, the emission light luminance of the red light source 51 in the red field is set at 60 cd/m², the emission light luminance of the green light source 52 in the green field is set at 120 cd/m², and the emission light luminance of the blue light source 53 in the blue field is set at 10 cd/m².

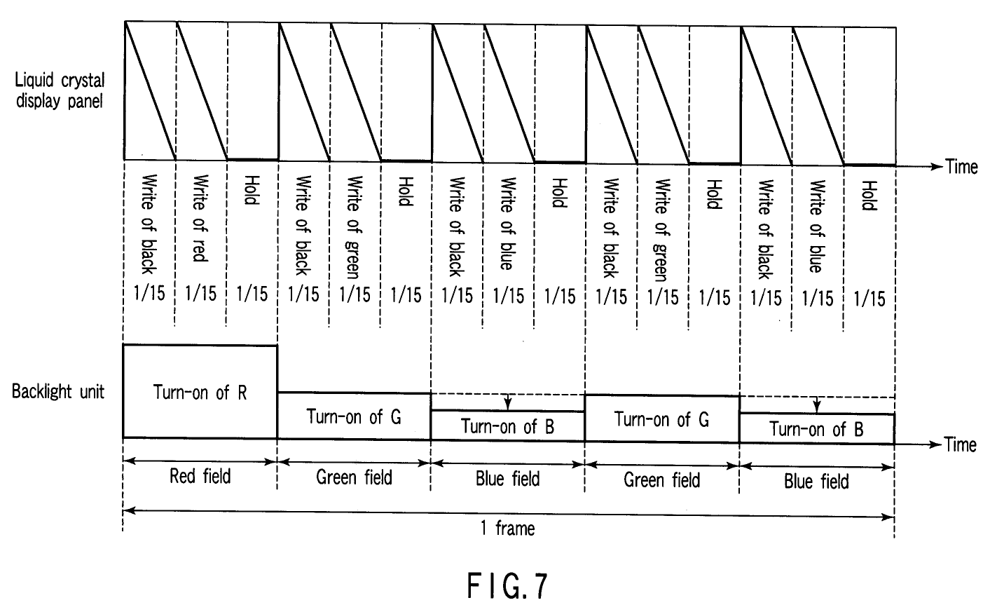

FIG. 7 shows the case of a 5-field structure in 15×-speed driving. In 1 frame, a red field period corresponding to a 3/15 frame period, a green field period corresponding to a 3/15 frame period, a blue field period corresponding to a 3/15 frame period, a green field period corresponding to a 3/15 frame period and a blue field period corresponding to a 3/15 frame period are successively assigned. The display control circuit 60 turns on the red light source 51 in the red field period ( 3/15 frame period), then turns on the green light source 52 in the first green field period ( 3/15 frame period), then turns on the blue light source 53 in the first blue field period ( 3/15 frame period), then turns on the green light source 52 in the second green field period ( 3/15 frame period), and then turns on the blue light source 53 in the second blue field period ( 3/15 frame period). In short, the light emission period ( 6/15 frame period) of each of the green light source 52 and the blue light source 53 in the 1 frame is set to be longer than the light emission period ( 3/15 frame period) of the red light source 51.

On the other hand, in the liquid crystal display panel 1, a 1/15 frame period of 1 frame is assigned as a black insertion period in each of the field periods of the respective colors. The display control circuit 60 executes driving so as to write a black image in the liquid crystal display panel 1 in each black insertion period. Thus, in 1 frame, the time opening ratio for each of the blue light source 53 and green light source 52 is greater than the time opening ratio for the red light source 51.

At the same time, the display control circuit 60 decreases the emission light luminance of the blue light source 53. For example, in a case where the luminance ratio of R:G:B is 3:6:1 and a white luminance of about 200 cd/m² is to be output, the emission light luminance of the red light source 51 in the red field is set at 60 cd/m², the emission light luminance of the green light source 52 in the green field is set at 60 cd/m², and the emission light luminance of the blue light source 53 in the blue field is set at 10 cd/m².

According to the structures shown in FIG. 6 and FIG. 7, it is possible to maintain the white balance while reducing coloring of the transmissive light that emerges from the liquid crystal display panel at the time of black display. In addition, color breakup of a specific color can be improved, and a liquid crystal display device with good display quality can be provided.

The present invention is not limited directly to the above-described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

In the above-described embodiment, the problem of coloring of a black image, which occurs due to leak of a greater amount of light of a blue wavelength than light of other wavelengths, is improved by reducing the emission light luminance of the blue light source 53. Conversely, the emission light luminance of the other color light sources, that is, the red light source 51 and green light source 52, may be increased to equalize the amount of leak light from the liquid crystal display panel 1 between the respective colors. Thereby, the coloring of the black image can be improved. In this case, the white balance deviates in such a direction that blue becomes deficient. Thus, in the liquid crystal display panel 1, the time opening ratio in the period in which the blue light source 53 emits light is set to be greater than the reference opening ratio, or the time opening ratio in the period in which the red light source 51 and green light source 52 emit light is set to be less than the reference opening ratio. Thereby, a predetermined white balance can be obtained.

In the above-described embodiment, the correction method in the case of bluish coloring of the black image has been discussed. Needless to say, even in the case where the black image becomes greenish or reddish due to coloring, the same correction can be executed and the same advantage can be obtained by controlling the time opening ratio and emission light luminance of the color light source that emits light of the color which is associated with the coloring.

In the above-described embodiment, 1 frame is composed of the red field, green field and blue field. It is possible, however, to add a white field (i.e. a field in which the red light source, green light source and blue light source are turned on at the same time) to the fields of these three primary colors, thereby constituting 1 frame. The invention is not limited to the example in which the three primary colors of additive color mixture are used. 1 frame may be formed of fields using the colors of subtractive color mixture, that is, a cyan field (i.e. a field in which the green light source and blue light field are turned on at the same time), a magenta field (i.e. a field in which the red light source and blue light field are turned on at the same time), and a yellow field (i.e. a field in which the green light source and red light source are turned on at the same time) (where necessary, a black field may be added). Furthermore, a field of at least one of the three primary colors of additive color mixture (red, green and blue) and a field of at least one of the three primary colors of subtractive color mixture (cyan, magenta and yellow) may be combined to form 1 frame.

What is claimed is:

1. A liquid crystal display device which performs color display by sequentially displaying different color images in a time division manner and mixing the color images, comprising:
a liquid crystal display panel in which a liquid crystal layer is held between a pair of substrates;
color light sources of a plurality of colors; and
control means for controlling each of the color light sources and the liquid crystal display panel,
wherein the control means controls a time opening ratio and an emission light luminance of one of the color light sources, which emits light of a color with which coloring occurs in transmissive light emerging from the liquid crystal display panel at a time of black display, thereby reducing the coloring of the transmissive light and maintaining a white balance.

2. The liquid crystal display device according to claim 1, wherein the color light sources include a first color light source and a second color light source which emits light of a color different from a color of the first color light source, and
the control means sets, in a case where the transmissive light emerging from the liquid crystal display panel is colored with the color of the first color light source at the time of black display, the time opening ratio of the first color light source to be greater than the time opening ratio of the second color light source.

3. The liquid crystal display device according to claim 2, wherein the control means sets a field period of a first color image, which is displayed in sync with light emission of the first color light source, to be equal to a field period of a second color image, which is displayed in sync with light emission of the second color light source, and sets a black insertion period in the field period of the first color image to be shorter than a black insertion period in the field period of the second color image.

4. The liquid crystal display device according to claim 3, wherein the control means sets a light emission period, in which the first color light source is caused to emit light, to be equal to a light emission period, in which the second color light source is caused to emit light.

5. The liquid crystal display device according to claim 2, wherein the control means sets a field period of a first color image, which is displayed in sync with light emission of the first color light source, to be longer than a field period of a second color image, which is displayed in sync with light emission of the second color light source, and sets a black insertion period in the field period of the first color image to be equal to a black insertion period in the field period of the second color image.

6. The liquid crystal display device according to claim 5, wherein the control means sets a light emission period, in which the first color light source is caused to emit light, to be longer than a light emission period, in which the second color light source is caused to emit light.

7. The liquid crystal display device according to claim 1, wherein said one of the color light sources is a blue light source.

8. The liquid crystal display device according to claim 1, wherein each of the color light sources is composed of a light-emitting diode.

9. The liquid crystal display device according to claim 8, wherein the control means controls the emission light luminance by an amount of electric current that is supplied to each of the color light sources.

10. The liquid crystal display device according to claim 1, wherein an OCB mode is applied to the liquid crystal display panel.

11. A liquid crystal display device which performs color display by sequentially displaying different color images in a time division manner and mixing the color images, comprising:
a liquid crystal display panel in which a liquid crystal layer is held between a pair of substrates;
an area light source unit which includes a red light source, a green light source and a blue light source and illuminates the liquid crystal display panel successively by the red light source, the green light source and the blue light source; and
control means for executing, when an emission light luminance of each of the color light sources, which is needed to obtain a predetermined white balance with transmissive light which emanates from the area light source unit and passes through the liquid crystal display panel, is set to be a reference luminance and a time opening ratio of the liquid crystal display panel, with which light from each of the color light sources is transmitted, is set to be a reference opening ratio, a control to make the emission light luminance of a predetermined one of the color light sources different from the reference luminance and to make the time opening ratio of the liquid crystal display panel at a time, when light from the predetermined color light source is transmitted, different from the reference opening ratio, thereby to obtain black of the predetermined white balance.

12. The liquid crystal display device according to claim 11, wherein the control means controls the emission light luminance and the time opening ratio with respect to the predetermined color light source, thereby to obtain an amount of transmissive light which is substantially equal to an amount of transmissive light necessary for obtaining the predetermined white balance.

13. The liquid crystal display device according to claim 11, wherein the control means sets the emission light luminance of the predetermined one of the color light sources to be lower than the reference luminance, and sets the time opening ratio of the liquid crystal display panel at a time, when light from the predetermined color light source is transmitted, to be greater than the reference opening ratio.

14. The liquid crystal display device according to claim 11, wherein the control means controls the time opening ratio by a black insertion period of each of the color images.
